(19) United States
(12) Patent Application Publication
(10) Pub. No.: US 2011/0113920 A1
(43) Pub. Date: May 19, 2011

(54) Steering Wheel Control Arm

(76) Inventor: Harlan Jay Lassen, San Juan Capistrano, CA (US)

(21) Appl. No.: 12/617,894

(22) Filed: Nov. 13, 2009

(51) Int. Cl. B62D 1/04; F16B 1/00

(52) U.S. Cl. 74/557; 403/404

(57) ABSTRACT

The Steering Wheel Control Arm is an accessory that allows the pilot of a marine vessel or a vehicle to steer the from a position on either side of the vessel or vehicle. The Steering Wheel Control Arm consists of a clamp and a telescoping arm that attach to the steering wheel of a boat. The telescoping arm pivots up and down and from side to side so the operator can easily switch from the port to starboard sides of the boat. When not in use the arm quickly detaches allowing piloting of the boat in a normal manner. This accessory allows skippers of wheel-driven boats to enjoy the same flexibility that tiller extensions have offered tiller piloted boats. Additionally it enables pilots of motorized vessels to continue steering the vessel while assisting with activities that may be taking place at the starboard or port sides of the boat.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the invention

This invention relates to the steering of boats, sailing vessels or other types of vehicles. Specifically it provides an accessory that allows the pilot of a vessel to move away from the helm position and steer from either the port or starboard sides of the vessel. It allows for increased safety when circumstances call for better visibility from areas on either side of the helm station.

2. Background of the Invention

Tiller extensions have been available for boats with tillers for many years. They have allowed the skipper to reposition himself away from the immediate helm area to provide greater visibility, increased stability of the boat or to assist with tasks in the immediate area.

Tiller extensions are often used in sailboat racing. When racing the may skipper need to move away from the helm area to view other boat traffic or a mark that may be hidden by the sails of his boat. Tiller extensions for tiller steered boats have helped to address that issue. Boats however piloted by steering wheels have not had an accessory to provide this same functionality. Unless the boat is equipped with autopilot it is difficult for the skipper to move from his helm position to increase his visibility or to assist with tasks taking place at the port or starboard sides of the vessel.

With the increased use of outboard stem seating popular on sailboats and motor boats the Steering Wheel Control Arm allows the pilot to comfortably steer the vessel from a seated position on either of the stem mounted outboard seats. Having the ability for the pilot to be seated for a period of time is especially desired during lengthy passages. The Steering Wheel Control Arm is an accessory that addresses these issues by allowing a skipper to move away from his steering wheel while continuing to maintain control of his vessel.

Many prior patents having to do with the control of vessels under way directly relate to the steering of outboard motors or rudders through the use of an extension that is connected to the rudder tiller or outboard motor tiller arm. Included in this group is U.S. Pat. No. 1,825,240, dated September 1931, U.S. Pat. No. 2,365,490 dated December 1944, U.S. Pat. No. 2,543,553 dated February 1951, and U.S. Pat. No. 5,492,032 dated February 1996. Additionally, U.S. Pat. No.1,351,382 dated August 1920 is an invention relating to a tractor guide wheel holder, U.S. Pat. No. 1,709,839 dated April 1929 is a patent dealing with the locking of steering wheels on motor vehicles, and U.S. Pat. No. 2,309,159 dated January 1943 is a foot steering device for outboard motors.

U.S. Pat. No. 5,492,032, February 1996 for a Boat Wheel Mounting Bracket most closely resembles the embodiment of the Steering Wheel Control Arm. It differs in the fact that it is comprised of blocks that are clamped to the spoke of a wheel which minimizes steering efficiency and maneuverability due to the fact that it is not positioned at the outermost area (rim) of the wheel. Additionally the design of the tiller extension does not allow for both vertical and horizontal motion of the extension limiting its use. U.S. Pat. No. 5,492,032 expired on Feb. 20, 2002.

### BRIEF SUMMARY OF THE INVENTION

The Steering Wheel Control Arm is an adjustable steering arm that attaches to the rim of a boat's existing steering wheel. The object of the Steering Wheel Control Arm is to allow the pilot to leave the normal helm position and continue to steer the vessel from a position on either side of the boat. The Steering Wheel Control Arm attaches to the steering wheel rim of a boat using a wheel clamp. The Steering Wheel Control Arm includes a quick release pin that allows the pilot to rapidly attach and detach the steering arm. The arm may telescope to allow the pilot to adjust the distance between himself and the steering wheel. It also rotates so the operator can easily switch from the port to starboard sides of the boat (and back) without the need for detachment. When not in use the arm quickly detaches allowing piloting of the boat at the normal helm position. The Steering Wheel Control Arm allows for increased forward visibility and enables piloting of the vessel from a seated position when the boat is equipped with stem mounted port and starboard seating. It allows for increased visibility when tacking or jibing sailboats. Additionally it enables pilots of motorized vessels to continue steering the vessel while assisting with activities that may be taking place at the starboard or port sides of the boat. This accessory allows skippers of boats piloted by steering wheels to enjoy the same flexibility that tiller extensions have offered tiller piloted boats for years.

### DESCRIPTION OF THE DRAWING

FIG. 1 is a front view of the preferred embodiment in its fully assembled state;

FIG. 2 shows an angular top view of the fully assembled embodiment;

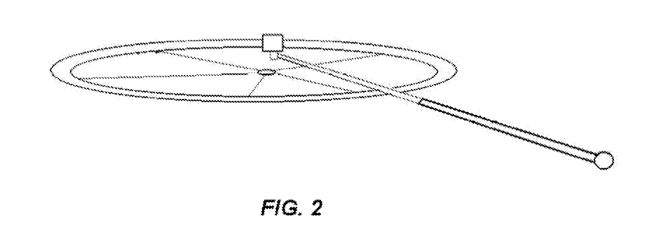

FIG. 3 shows the ability of the steering arm to move up and down and from side to side;

FIG. 4 shows a top view of the telescoping arm prior to its insertion into the wheel clamp;

FIG. 5 is a view of the wheel clamp at a point of initial assembly on the rim of the steering wheel;

FIG. 6 is a view of the wheel clamp mounted on the steering wheel prior to insertion of the lock down bolt;

FIG. 7 is a view showing the telescoping arm and grooved pin and clip which retains the detent pin. Additionally it shows the insertion of the detent pin into the wheel clamp;

FIG. 8 is view of the wheel clamp and telescoping arm showing the telescoping arm's connection to the wheel clamp.

### DETAILED DESCRIPTION OF THE PREFERRED EMBODIMENT

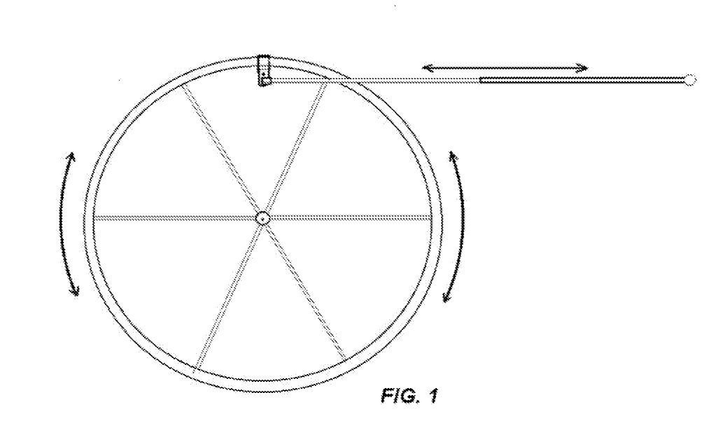

The Steering Wheel Control Arm consists of two elements as part of the embodiment. Those two elements are a wheel clamp 2 and a telescoping arm 3. FIG. 1 is an illustration that shows the boat steering wheel 1 with the wheel clamp 2 secured to the wheel and a telescoping arm 3 attached to the wheel clamp 2. FIG. 1 shows that horizontal movement of the Steering Wheel Control Arm results in movement of the steering wheel 1. The telescoping arm 3 has a handle 4 of basic configurations such as knobs or handle grips. The telescoping arm 3 can be made of materials that perform well in marine environments such as marine grade aluminum, stainless steel, carbon fiber and others commonly used on vessels today. Under normal piloting of the vessel the wheel clamp 2 would remain on the steering wheel 1 and the quick release telescoping arm 3 would be removed and reinserted as needed.

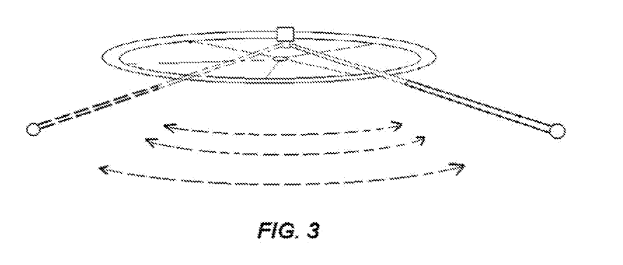

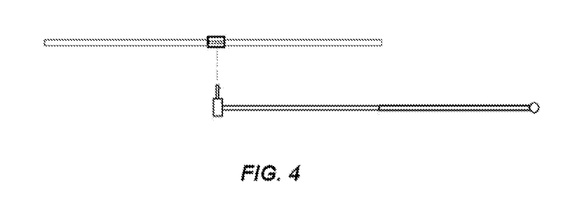

The telescoping arm 3 pivots freely up and down and from side to side so that it can be easily positioned on either the starboard or port side of the vessel as shown in FIG. 3. The head 7 of the telescoping arm 3 contains a detent pin 8 that quickly attaches and detaches from the wheel clamp 2. That process is depicted in FIGS. 4, 7, and 8.

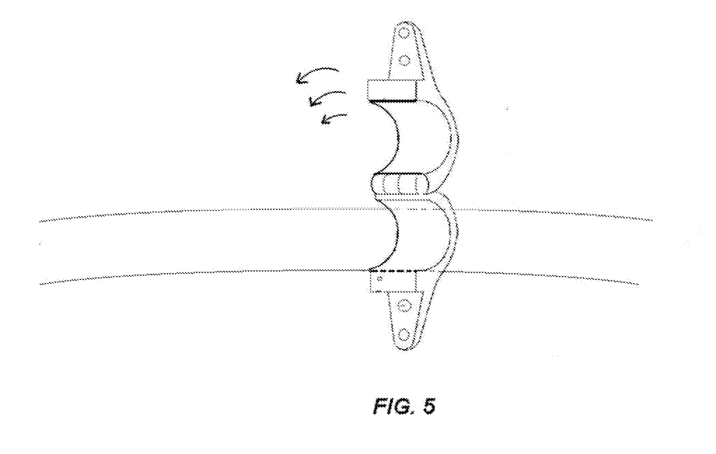

The point of initial assembly of the wheel clamp 2 onto the rim of the steering wheel 1 is depicted in FIG. 5.

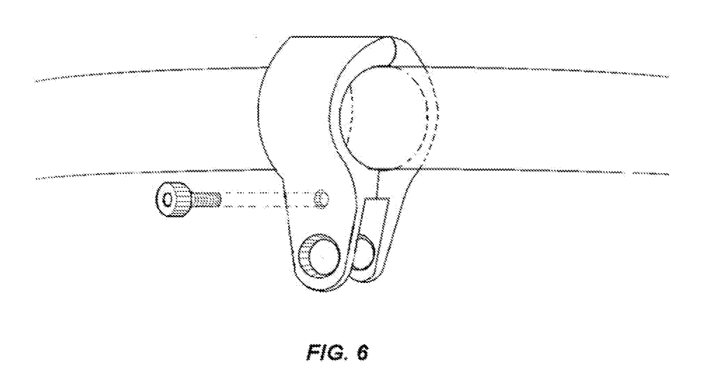

The wheel clamp 2 is hinged 10 to allow it to encompass the steering wheel rim 1 and be bolted 11 to the steering wheel rim 1. That process is shown in FIGS. 5 and 6. The wheel clamp 2 can be made of materials such as stainless steel, chromed Zamak or high-density nylon or plastic as long as it is solid and can handle stress loads. The wheel clamp 2 can also be produced in wood or other materials that are resistant to marine elements. The wheel clamp 2 can be of various sizes to accommodate the size and diameters of different types of sailboat and powerboat wheels. FIG. 6 shows the bolt 11 that is used to tightly secure the wheel clamp 2 onto the steering wheel 1. The bolt 11 is of marine grade and can be of various sizes as long as it can adequately secure the wheel clamp 2 to the steering wheel rim 1. The bolt 11 travels through the opening 12 and is received by the threaded hole 9 shown on FIGS. 5 and 6. The lower portion of both sides of the wheel clamp 2 has an opening 13 on the front side and back side of the wheel clamp 2 to receive the detent pin 8 at the end of the telescoping arm 3.

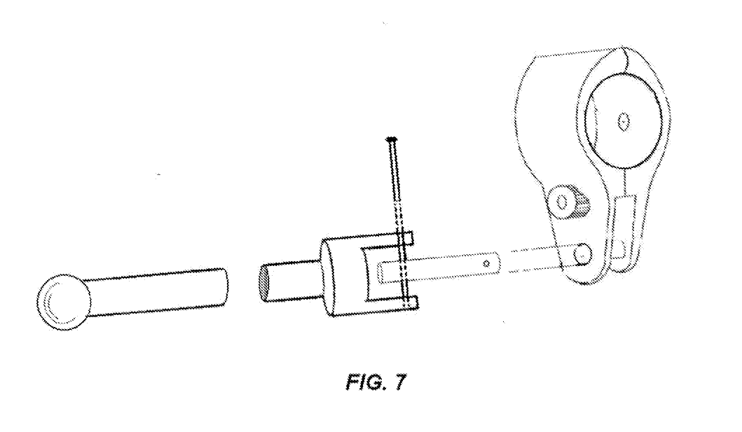

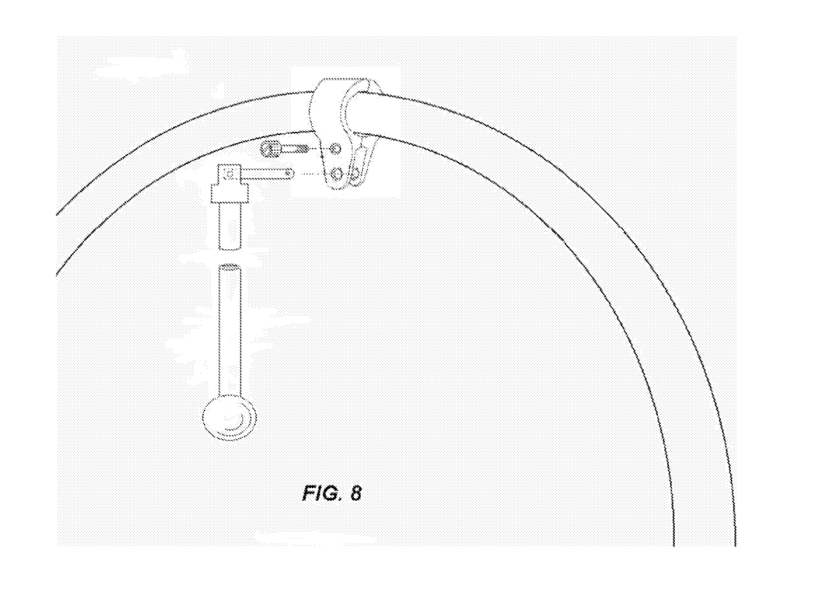

The telescoping arm 3 has a head 7 that retains the detent pin 8 by means of a grooved pin 14 and that extends through the head 7, through the detent pin 8 and back through the other side of the head 7 shown in FIG. 7. The grooved pin 14 is secured by a clip 15. The pin 14 that extends through the head 7 into the detent pin 8 must be positioned to allow free movement of the detent pin 8. A detent pin 8 is used to help insure that the telescoping arm 3 positively engages and disengages with the wheel clamp 2. Other types of pins 8 could be used such as ball lock pins, locking clamp pins, quick release ball lock pins, clevis pins, wire locking pins or cotter pins. FIG. 7 and FIG. 8 also show insertion of the detent pin 8 into the wheel clamp 2. FIG. 8 shows all parts in the embodiment of the wheel clamp 2 and telescoping arm 3.

The description of the Steering Wheel Control Arm should not limit the variability of its embodiment. Many types of modifications of this embodiment could be developed but the basic characteristic of providing the pilot of a vessel or a vehicle the capability to move away from the helm or steering position and steer from either the port or starboard sides is being claimed.

What is claimed as invention is:

I. A Steering Wheel Control Arm that enables the pilot to leave the normal helm or drivers position and steer the vessel or vehicle from a position on either side.

II. As pertains to claim I, movement of the Steering Wheel Control Arm results in movement of the steering wheel.

III. As set forth in claim I, the Steering Wheel Control Arm can be adapted for use on sailboats, powerboats or other types of vehicles.

IV. A clamp that is attached to the steering wheel rim of a boat and a telescoping arm that is attached to that clamp as set forth in claim 1;
a. The clamp can assume various configurations.
b. The clamp encompasses the rim or spoke of the boat's steering wheel.
c. The clamp may be attached to the telescoping arm in many different ways.
d. The clamp is removable.

V. As pertains to claim 1, the embodiment includes a telescoping arm that;
a. Pivots freely up and down and from side to side so that it can be easily positioned on either the starboard or port side of the vessel or sides of a vehicle.
b. Has a pin that can be of many different types that will allow it to remain securely in the hole of the clamp when in use but removed quickly when use is no longer required.
c. Is removable.
